(19) United States
(12) Patent Application Publication
(10) Pub. No.: US 2025/0382484 A1
(43) Pub. Date: Dec. 18, 2025

(54) Aqueous Ink Jet Ink Composition, Ink Storage Body, And Recording Method

(71) Applicant: SEIKO EPSON CORPORATION, Tokyo (JP)

(72) Inventors: Tasuku NAKAMURA, Matsumoto (JP); Kenta KIKUCHI, Suwa (JP)

(21) Appl. No.: 19/234,736

(22) Filed: Jun. 11, 2025

(30) Foreign Application Priority Data
Jun. 12, 2024 (JP) 2024-094863

(51) Int. Cl. C09D 11/326; B41J 2/175

(52) U.S. Cl. CPC C09D 11/326; B41J 2/17503

(57) ABSTRACT

An ink jet ink composition includes a pigment and a surfactant. The pigment includes carbon black derived from a vegetable oil or carbon black derived from a recycled raw material. The surfactant includes a surfactant A having an HLB value of 10 or more and less than 15 and a surfactant B which is an acetylene glycol-based surfactant having an HLB value of 3 or more and less than 10. The ink jet ink composition is an aqueous ink.

The present application is based on, and claims priority from JP Application Serial Number 2024-094863, filed Jun. 12, 2024, the disclosure of which is hereby incorporated by reference herein in its entirety.

### BACKGROUND

### 1. Technical Field

The present disclosure relates to an aqueous ink jet ink composition, an ink storage body, and a recording method.

### 2. Related Art

Ink jet recording methods can record high-definition images with a relatively simple apparatus and have been rapidly developed in various fields. In recent years, there has been a concern about environmental problems, and inks have been developed in consideration of environmental problems. As a material for such an ink, plant-derived pigments have been attracting attention. For example, among carbon black, plant charcoal-derived carbon black produced using Binchotan, bamboo charcoal, or the like is known.

For example, for the purpose of providing an aqueous ink jet ink composition excellent in environmental compatibility and storage stability, JP-A-2023-128719 discloses an aqueous ink jet ink composition containing a biologically derived coloring material such as Binchotan and bamboo charcoal, a biologically derived dispersant, and a biologically derived organic solvent. The organic solvent includes a compound having a hydroxy group and a Hansen solubility parameter of 24.0 (cal/cm³)^{1/2} or more.

However, since carbon black derived from plant charcoal such as Binchotan and bamboo charcoal contains large amounts of impurities and the impurities tend to be difficult to remove, there is a problem from the viewpoint of dispersion stability and storage stability. In addition, since the plant charcoal-derived carbon black has a relatively large particle diameter and tends to be non-uniform, there is room for improvement in ejection stability.

### SUMMARY

An ink jet ink composition according to an aspect of the present disclosure includes a pigment and a surfactant. The pigment includes carbon black derived from a vegetable oil or carbon black derived from a recycled raw material. The surfactant includes a surfactant A having an HLB value of 10 or more and less than 15 and a surfactant B which is an acetylene glycol-based surfactant having an HLB value of 3 or more and less than 10. The ink jet ink composition is an aqueous ink.

An ink storage body according to an aspect of the present disclosure includes the above-described ink jet ink composition and a container storing the ink jet ink composition.

A recording method according to an aspect of the present disclosure includes ejecting the above-described ink jet ink composition from an ink jet head to attach the ink jet ink composition to a recording medium.

### BRIEF DESCRIPTION OF THE DRAWINGS

FIG. 1 is Table 1 showing the composition of each composition used in Examples and evaluation results thereof.

FIG. 2 is Table 2 showing the composition of each composition used in Examples and evaluation results thereof.

FIG. 3 is Table 3 showing the composition of each composition used in Comparative Examples and Reference Examples and evaluation results thereof.

FIG. 4 is a schematic sectional view showing an example of a recording apparatus which can be used in the present embodiment.

FIG. 5 is a schematic perspective view showing an example of an ink storage body which can be used in the present embodiment.

FIG. 6 is a schematic cross-sectional view showing another example of the ink storage body which can be used in the present embodiment.

FIG. 7 is a schematic perspective view showing another example of the recording apparatus which can be used in the present embodiment.

### DESCRIPTION OF EMBODIMENTS

An embodiment of the present disclosure (hereinafter, referred to as the “present embodiment”) will be described in detail below with reference to the drawings as necessary, but the present disclosure is not limited thereto, and various modifications can be made without departing from the gist of the present disclosure.

### 1. Aqueous Ink Jet Ink Composition

An aqueous ink jet ink composition (hereinafter, also simply referred to as the “ink composition”) of the present embodiment contains a pigment including carbon black derived from a vegetable oil or carbon black derived from a recycled raw material, and a surfactant including a surfactant A having an HLB value of 10 or more and less than 15 and a surfactant B which is an acetylene glycol-based surfactant having an HLB value of 3 or more and less than 10, thereby providing an aqueous ink jet ink composition having excellent ejection stability and storage stability.

Carbon black derived from a vegetable oil (hereinafter, also referred to as the “vegetable oil CB”) is similar in production process to petroleum carbon black, and tends to be excellent in dispersion stability and the like as compared with plant charcoal-derived carbon black. However, since the vegetable oil as a raw material contains various organic substances, the produced vegetable oil CB contains a large number of voids having different sizes, shapes, and the like therein. In addition, a portion having relatively high hydrophobicity (a portion having relatively low hydrophilicity) and a portion having relatively low hydrophobicity (a portion having relatively high hydrophilicity) may be mixed in the structure. One of the reasons for this is presumed to be that, in the produced vegetable oil CB, the vegetable oil that has not been completely carbonized is partially mixed as an impurity in the vegetable oil CB, the vegetable oil contains various organic substances, and the degree of mixing of impurities varies depending on the portion of the vegetable oil CB.

Bubbles tend to remain in such voids, and the bubbles remaining in the vegetable oil CB form bubble nuclei and grow due to dissolved nitrogen in the ink composition. It is considered that the bubbles grown in this manner are separated from the pigment and cause deterioration in ejection stability.

In particular, the bubbles are likely to grow when the dissolved nitrogen concentration of the ink is relatively high. In addition, even in a case where the dissolved nitrogen concentration in the ink is not high immediately after production, when an ink storage body in which the gas barrier performance is not high is used, there is a concern that the dissolved nitrogen concentration in the ink may increase over time due to permeation of air.

In addition, carbon black derived from a recycled raw material obtained by thermally decomposing waste such as waste tires (hereinafter, also referred to as the “recycled CB”) has the same problem as the vegetable oil CB. Since the raw material waste contains various components, the obtained recycled CB contains a large number of voids having different sizes, shapes, and the like therein, and a portion having high hydrophilicity and a portion having low hydrophilicity may be mixed in the structure. Therefore, as in the case of the vegetable oil CB, a problem of deterioration in ejection stability may occur.

Therefore, in the present embodiment, two kinds of surfactants, i.e., the surfactant A and the surfactant B, are used. As a result, wettability in the voids of the vegetable oil CB and the recycled CB can be enhanced, the removal of fine bubbles can be promoted, and the bubbles can be prevented from remaining. Specifically, for example, it is considered that the surfactant A having an HLB value of 10 or more and less than 15 increases wettability of the portion having relatively low hydrophobicity in the vegetable oil CB or the recycled CB, and the surfactant B which is an acetylene glycol-based surfactant having an HLB value of 3 or more and less than 10 increases wettability of the portion having relatively high hydrophobicity, whereby wettability of the entire vegetable oil CB is improved, removal of bubbles from the vegetable oil CB and the recycled CB is promoted, and good ejection stability can be maintained even when dissolved nitrogen increases over time.

Components which may be included in the ink composition according to the present embodiment and a method for producing the same will be described in detail below.

### 1. 1. Pigment

The pigment of the present embodiment includes carbon black derived from a vegetable oil or carbon black derived from a recycled raw material. Since these pigments contain various organic substances from raw materials, the pigments contain voids having different sizes and shapes derived from the organic substances, and also contain a portion having high hydrophilicity and a portion having low hydrophilicity. Therefore, it is difficult to remove bubbles, and ejection failure is likely to occur. The effect of the present disclosure is thus significant.

Examples of the carbon black derived from a vegetable oil include carbon black obtained by subjecting a vegetable oil to incomplete combustion or thermal decomposition reaction at a high temperature, and carbon black obtained by collecting smoke generated by burning a vegetable oil (lamp black using a vegetable oil as a raw material).

The vegetable oil is not particularly limited, and examples thereof include castor oil, pine rosin oil, coconut oil, rapeseed oil, and palm oil.

The carbon black derived from a recycled raw material is not particularly limited, and examples thereof include carbon black obtained by similarly subjecting waste such as waste tires to incomplete combustion or thermal decomposition.

Carbon black derived from a recycled raw material (recycled CB) can also be used to provide an environmentally friendly ink because, by using a recycled raw material, the amount of a petroleum-derived component to be newly used can be reduced, and the amount of carbon dioxide emission can be reduced as compared with the case where a petroleum-derived component is newly used.

These pigments are not particularly limited, but may be, for example, a self-dispersible pigment in which a hydrophilic group is introduced to the surface of a pigment particle by utilizing a chemical reaction.

The self-dispersible pigment is a pigment that can be dispersed in an aqueous medium without a dispersant. Examples of such a self-dispersible pigment include a pigment made dispersible in an aqueous medium by performing a physical and/or chemical surface treatment to introduce a hydrophilic functional group into the pigment through a chemical bond directly or via an organic group.

The hydrophilic group is preferably an acidic group, and examples thereof include a carboxy group, a sulfo group, and a phosphorus-containing acid group. Examples of the phosphorus-containing acid group include a phosphoric acid group and a phosphonic acid group.

The resin-dispersed pigment is a pigment in which a pigment is dispersed in an aqueous medium by a resin. The resin adheres or adsorbs to the surface of the pigment. As the resin, for example, a dispersant resin or the like is used.

Among these, a self-dispersible pigment is preferable. Since the self-dispersible pigment has a hydrophilic group on the surface thereof, the effect of the surfactants A and B to remove bubbles in the voids of carbon black tends to be further improved.

The content of the carbon black derived from a vegetable oil and the carbon black derived from a recycled raw material is preferably 0.5% by mass or more and 10% by mass or less with respect to the total amount of the ink composition. The content is more preferably 2.5% by mass or more and 7.5% by mass or less, 3% by mass or more and 5% by mass or less, or 3.5% by mass or more and 4.5% by mass or less. When the content of the pigment is within the above ranges, ejection stability and storage stability tend to be further improved.

The volume-average particle size D50 of secondary particles of the carbon black derived from a vegetable oil or the carbon black derived from a recycled raw material is preferably 30 nm or more and 200 nm or less, 50 nm or more and 150 nm or less, or 75 nm or more and 125 nm or less. Further, the volume-average particle size D50 is more preferably 80 to 120 nm, 95 to 115 nm, or 100 to 110 nm.

When the volume-average particle size D50 is within the above ranges, ejection stability and storage stability tend to be further improved.

In the present embodiment, primary particles refer to independent particles which are not aggregated, and secondary particles refer to particles which are dispersed as one independent particle in the ink. The secondary particles may be, for example, aggregated particles formed by aggregation of two or more primary particles. The carbon black derived from a vegetable oil or the carbon black derived from a recycled raw material is likely to take the form of secondary particles, i.e., aggregated particles, and may have voids between primary particles constituting the aggregated particles. The surfactants A and B easily remove bubbles trapped in such voids.

In the present embodiment, the volume average particle diameter D50 refers to a median diameter on a volume average basis. The volume average particle diameter D50 can be measured using, for example, a dynamic light scattering method.

### 1. 2. Surfactant

The surfactant includes the surfactant A having an HLB value of 10 or more and less than 15, and the surfactant B which is an acetylene glycol-based surfactant having an HLB value of 3 or more and less than 10, and may include another surfactant as necessary.

The surfactant of the present embodiment is preferably the surfactant A and the surfactant B each having an HLB value in a specific range. In the present embodiment, a hydrophile-lipophile balance (HLB) value is a value proposed by Davies et al. for evaluating hydrophilicity of a compound, is a numerical value obtained by the Davies method defined in the literature “J. T. Davies and E. K. Rideal, “Interface Phenomena,” 2nd ed., Academic Press, New York 1963,” and indicates a value calculated by the following formula. The HLB value is a value for evaluating hydrophilicity of a compound, and there is a tendency that the larger the HLB value, the higher the hydrophilicity, and the smaller the HLB value, the higher the hydrophobicity. HLB value=7+Σ[1]−Σ[2] where [1] represents the number of hydrophilic groups, and [2] represents the number of hydrophobic groups.

### 1. 2. 1. Surfactant A

The surfactant A increases wettability of the portion having relatively low hydrophobicity in the vegetable oil CB or the recycled CB, promotes removal of bubbles, and can favorably maintain ejection stability even in a case where a storage body in which dissolved nitrogen increases over time is used. The HLB value of the surfactant A is 10 or more and less than 15, preferably 11 or more and 14.5 or less, and 12 or more and 14 or less. When the HLB value of the surfactant A is within the above ranges, storage stability tends to be further improved.

The surfactant A is not particularly limited as long as the HLB value is 10 or more and less than 15, and examples thereof include a silicone-based surfactant, an acetylene glycol-based surfactant, and a fluorine-based surfactant. One kind of surfactant A may be used alone, or two or more kinds thereof may be used in combination.

Among these, one or more selected from the group consisting of silicone-based surfactants and acetylene glycol-based surfactants are preferable, and an acetylene glycol-based surfactant is more preferable. By using such a surfactant, storage stability and ejection stability tend to be further improved. In addition, since the acetylene glycol-based surfactant is unlikely to foam and has a carbon skeleton like carbon black, the acetylene glycol-based surfactant tends to have high affinity with carbon black and provide high bubble removal efficiency.

The acetylene glycol-based surfactant used as the surfactant A is preferably an acetylene glycol-based surfactant having a polyether modifier group. Examples of the acetylene glycol-based surfactant used as the surfactant A include compounds represented by the same formula as Formula (1) described below except that m and n are each independently an integer of 1 or more and m+n is 50 or less in Formula (1). Preferably, m and n are each independently 3 to 40, 4 to 30, 6 to 20, 8 to 16, or 11 to 15.

Commercially available products of the silicone-based surfactant having an HLB value of 10 or more and less than 15 are not particularly limited, and examples thereof include KF-640 and KF-6013 (manufactured by Shin-Etsu Chemical Co., Ltd.).

Commercially available products of the acetylene glycol-based surfactants having an HLB value of 10 or more and less than 15 are not particularly limited, and examples thereof include E1010 and EXP4200 (manufactured by Nissin Chemical Industry, Co., Ltd.).

The content of the surfactant A is preferably 0.1 mass % or more and 2.0 mass % or less, 0.1 mass % or more and 1.5 mass % or less, 0.2 mass % or more and 1.3 mass % or less, 0.3 mass % or more and 1.1 mass % or less, or 0.4 mass % or more and 0.9 mass % or less with respect to the total amount of the ink composition. When the content of the surfactant A is within the above ranges, ejection stability and storage stability tend to be further improved.

### 1. 2. 2. Surfactants B

The surfactant B is an acetylene glycol-based surfactant having an HLB value of 3 or more and less than 10. By using the acetylene glycol-based surfactant having an HLB value of 3 or more and less than 10, wettability of the portion having relatively high hydrophobicity of carbon black can be increased, removal of bubbles can be promoted, and good ejection stability can be maintained. In addition, since the acetylene glycol-based surfactant is a surfactant which is unlikely to foam and has the same carbon skeleton as carbon black, it is considered that the acetylene glycol-based surfactant has high affinity and high bubble removal efficiency compared to other surfactants.

The acetylene glycol-based surfactant used as the surfactant B is preferably an acetylene glycol-based surfactant having or not having a polyether modifier group. Examples thereof include a compound represented by the following formula (1):

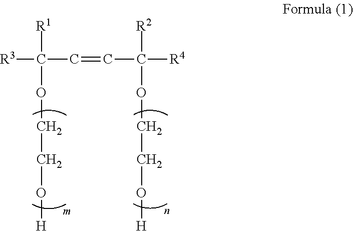

where R¹ to R⁴ each independently represent an alkyl group having 1 to 4 carbon atoms, m and n each independently represent 0 or an integer of 1 or more, and m+n is 20 or less.

Each of m and n is preferably independently 10 or less, 5 or less, more preferably 2 or less, and particularly preferably 0.

Preferred examples of R¹ to R⁴ include methyl, ethyl, n-propyl, isopropyl, n-butyl, sec-butyl, and tert-butyl.

The HLB value of the surfactant B is 3 or more and less than 10, and preferably 4 or more and 9.5 or less, 5 or more and 9 or less, or 6 or more and 8.5 or less. When the HLB value of the surfactant B is within the above ranges, storage stability tends to be further improved.

The acetylene glycol-based surfactant having an HLB value of 3 or more and less than 10 is not particularly limited, and examples thereof include SURFYNOL SE, SURFYNOL 440, and SURFYNOL 104 (product names, manufactured by Nissin Chemical Industry, Co., Ltd.).

The content of the surfactant B is preferably 0.1 mass % or more and 1.0 mass % or less, 0.15 mass % or more and 0.75 mass % or less, or 0.2 mass % or more and 0.5 mass % or less with respect to the total amount of the ink composition. When the content of the surfactant B is within the above ranges, ejection stability and storage stability tend to be further improved.

The mass ratio (B/A) of the content of the surfactant B to the content of the surfactant A is preferably 0.1 or more and 1.5 or less, 0.1 or more and 1.0 or less, 0.2 or more and 0.9 or less, 0.3 or more and 0.8 or less, or 0.4 or more and 0.7 or less. When the mass ratio of the content of the surfactant B to the content of the surfactant A is within the above ranges, ejection stability and storage stability tend to be further improved.

### 1. 2. 3. Additional Surfactant

Although an additional surfactant is a surfactant other than the surfactant A and the surfactant B, and is not particularly limited, examples thereof include a silicone-based surfactant, an acetylene glycol-based surfactant, and a fluorine-based surfactant.

The content of the additional surfactant is 0 mass % or more and 0.5 mass % or less, 0.01 mass % or more and 0.4 mass % or less, 0.02 mass % or more and 0.3 mass % or less, 0.03 mass % or more and 0.2 mass % or less, and may be 0.04 mass % or more and 0.1 mass % or less with respect to the total amount of the ink composition. The additional surfactant need not be included. When the content of the additional surfactant is within the above ranges, ejection stability and storage stability tend to be further improved.

### 1. 3. Organic Solvent

The ink composition of the present embodiment may include an organic solvent. Examples of the organic solvent include water-soluble organic solvents such as a polyol and a glycol ether. One kind of organic solvent may be used alone, or two or more kinds thereof may be used in combination.

The polyol is a compound having two or more hydroxyl groups in a molecule, and preferred examples thereof include a compound which is a hydrocarbon having two or more hydroxy groups in a molecule and may have an ether group in the hydrocarbon skeleton.

Examples of the polyol include ethylene glycol, propylene glycol, 1,2-propanediol, 1,2-butanediol, 1,2-pentanediol, 1,2-hexanediol, 1,2-octanediol, 1,3-propanediol, 1,4-butanediol, 1,6-hexanediol, diethylene glycol, triethylene glycol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, and glycerin.

The glycol ether may be a monoether or diether of an alkylene glycol, and is preferably an alkyl ether. Specific examples thereof include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, and tripropylene glycol monobutyl ether; and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Among the organic solvents described above, the ink composition of the present embodiment may include an organic solvent C having an SP value of 8 (cal/cm³)^{1/2} or more and 14 (cal/cm³)^{1/2} or less.

The SP value of the organic solvent C is preferably 8 (cal/cm³)^{1/2} or more and 14 (cal/cm³)^{1/2} or less, 9 (cal/cm³)^{1/2} or more and 13 (cal/cm³)^{1/2} or less, 10 (cal/cm³)^{1/2} or more and 12.5 (cal/cm³)^{1/2} or less. When the SP value of the organic solvent C is 8 (cal/cm³)^{1/2} or more, compatibility of the components contained in the ink composition is improved, and storage stability and ejection stability of the ink composition tend to be further improved. On the other hand, when the SP value of the organic solvent C is 14 (cal/cm³)^{1/2} or less, solubility of the surfactant B tends to be further improved. In particular, the surfactant B has a relatively low solubility in water, and for example, in a state where ink is dried in a nozzle and the amount of water is reduced, discharge failure is likely to occur. However, by including the organic solvent C, ejection stability tends to be further improved even in such a state.

The SP value in the present specification is a solubility parameter calculated based on the Hansen method. According to the Hansen method, the SP value is represented by the following formula:

$${δ}^{2} = {δ}_{d}^{2} + {δ}_{p}^{2} + {δ}_{h}^{2}$$

where δₐ is a solubility parameter corresponding to the dispersion force term, δₚ is a solubility parameter corresponding to the intermolecular force term, and on is a solubility parameter corresponding to the hydrogen-bonding term.

The SP value is based on the idea that two substances having similar intermolecular interactions are easily dissolved in each other. The SP value can be not only roughly estimated by calculation, but also determined experimentally or empirically, and many SP values are described in literatures. In the present embodiment, as the SP value, a value derived by using HSPiP, which is calculation software, can be used.

The unit of the SP value in the present embodiment is (cal/cm³)^{1/2}. The range of the SP value from 8 (cal/cm³)^{1/2} to 14 (cal/cm³)^{1/2} can also be expressed as 16.4 (J/cm³)^{1/2} to 28.6 (J/cm³)^{1/2} using another unit.

The organic solvent C preferably contains one or more selected from the group consisting of polyols and glycol ethers. By using the organic solvent C as described above, storage stability and ejection stability of the ink composition tend to be further improved. The polyols having an SP value of 8 (cal/cm³)^{1/2} or more and 14 (cal/cm³)^{1/2} or less preferably satisfy the above-mentioned SP values, and are preferably alkanediols having 5 or more carbon atoms, more preferably an alkanediol having 5 to 10 carbon atoms, and further preferably 1,2-alkanediol.

Specific examples thereof include, but are not limited to, 1,2-hexanediol. In addition, the glycol ethers having an SP value of 8 (cal/cm³)^{1/2} or more and 14 (cal/cm³)^{1/2} or less are not particularly limited, and examples thereof include tripropylene glycol monomethyl ether.

The content of the organic solvent C is preferably 1.0 mass % or more and 15 mass % or less, 2.0 mass % or more and 11 mass % or less, or 3.0 mass % or more and 8 mass % or less with respect to the total amount of the ink composition. When the content of the organic solvent C is within the above ranges, ejection stability and storage stability tend to be further improved.

The content of the entire organic solvent is preferably 5.0 mass % or more and 30 mass % or less, 7.5 mass % or more and 25 mass % or less, and 10 mass % or more and 20 mass % or less with respect to the total amount of the ink composition. When the content of the entire organic solvent is within the above ranges, ejection stability and storage stability tend to be further improved.

The content of the organic solvent C is preferably 10 to 55 mass %, 20 to 50 mass %, or 25 to 45 mass % with respect to the total amount of the entire organic solvent. When the content of the organic solvent C is within the above ranges, ejection stability and storage stability tend to be further improved.

The mass ratio (B/C) of the content of the surfactant B to the content of the organic solvent C is preferably 0.5 or less, 0.4 or less, 0.3 or less, 0.2 or less, or 0.15 or less. Further, the mass ratio (B/C) is preferably 0.01 or more, 0.02 or more, or 0.03 or more. By setting the mass ratio of the content of the surfactant B to the organic solvent C within the above ranges, ejection stability and storage stability tend to be further improved.

### 1. 4. Water

The ink composition of the present embodiment is an aqueous ink composition including water. The aqueous ink composition is an ink composition including at least water as a main solvent component of ink.

The content of water is preferably 45 mass % or more, 50 mass % or more and 97 mass % or less, 60 mass % or more and 95 mass % or less, 65 mass % or more and 90 mass % or less, or 70 mass % or more and 85 mass % or less with respect to the total amount of the ink composition. By setting the content of water within the above ranges, storage stability tends to be further improved.

### 1. 5. Other Components

The ink composition may contain a component other than the components described above. As other components, various additives such as a dissolution aid, a viscosity modifier, a pH adjuster, an antioxidant, a preservative, an antifungal agent, a corrosion inhibitor, and a chelating agent for capturing metal ions that affect dispersion can be appropriately added. For example, triethanolamine may be included as a pH adjuster.

### 2. Ink Storage Body

An ink storage body according to the present embodiment includes the ink jet ink composition described above and a container which stores the ink jet ink composition. In the present embodiment, the ink storage body refers to a state in which a container stores ink.

The ink composition stored in the ink storage body preferably has a dissolved nitrogen concentration of 2 ppm or more in the storage body. As the nitrogen concentration in the ink increases, the vegetable oil CB and the recycled CB having a large number of voids easily take in nitrogen, and thus the effect of the present disclosure is remarkable. The dissolved nitrogen concentration of the ink may be less than 2 ppm at the time of shipment of the ink storage body, or may become 2 ppm or more until the ink storage body is started to be used in a printer after shipment.

In a case where the dissolved nitrogen concentration in the container is allowed to be high, for example, it is possible to omit a step of performing sufficient deaeration during ink preparation, and it is possible to reduce the number of steps of ink production, for example. In addition, since the ink container does not need to have a high gas barrier performance, the degree of freedom in container design is improved. Accordingly, for example, a member having excellent flexibility can be used, and it is possible to increase the capacity of the container and to reduce costs.

### 2. 1. Container

The container is not particularly limited, and examples thereof include an ink cartridge, an ink pack, an ink bottle, an ink tank, a bottle, and a can. Among these, from the viewpoint of versatility, an ink cartridge, an ink pack, an ink bottle, and an ink tank are preferable, and an ink pack and an ink bottle are more preferable.

### 2. 1. 1. Ink Pack

The ink pack is not particularly limited, but may have, for example, a pack main body for storing ink and an ink supply port. The constituent material of the pack main body is not particularly limited, and may have, for example, a multilayer structure in which a resin film substrate layer serving as a substrate for ensuring basic strength is provided, and a gas barrier layer for imparting gas barrier properties to the resin film substrate layer is laminated as necessary.

The resin constituting the resin film substrate layer is not particularly limited, and examples thereof include a polyester resin and a polyolefin resin.

The gas barrier layer is not particularly limited, but is preferably a resin layer having excellent gas barrier performance, a vapor deposition layer of a metal or a metal compound, or the like. For example, when an aluminum foil layer is attached, the gas barrier performance is high, and the dissolved nitrogen concentration is less likely to increase even after long-term storage.

An ink pack with a resin layer used as the gas barrier layer is useful because such an ink pack is not readily torn. Since the gas barrier performance is slightly lower than that of a metal foil layer, the dissolved nitrogen concentration tends to increase during storage, and even in a case where the dissolved nitrogen concentration is low immediately after the ink is poured into the ink storage body, the dissolved nitrogen concentration is highly likely to increase before use, and thus the present disclosure is particularly useful.

In addition, a gas barrier layer using a vapor deposition layer of a metal or a metal compound also has a slightly lower gas barrier performance than a metal foil layer, and thus the dissolved nitrogen concentration tends to increase during storage, and the present disclosure is particularly useful in the same manner. Further, the present disclosure is also useful in that the ink pack is not readily torn.

The resin layer having excellent gas barrier performance is not particularly limited, and examples thereof include nylon, an ethylene-vinyl alcohol copolymer resin, and polyvinylidene chloride. Since the gas barrier performance is slightly inferior to that of a metal or metal compound layer, it is preferable to use a resin layer having a thickness slightly larger than that of a metal film.

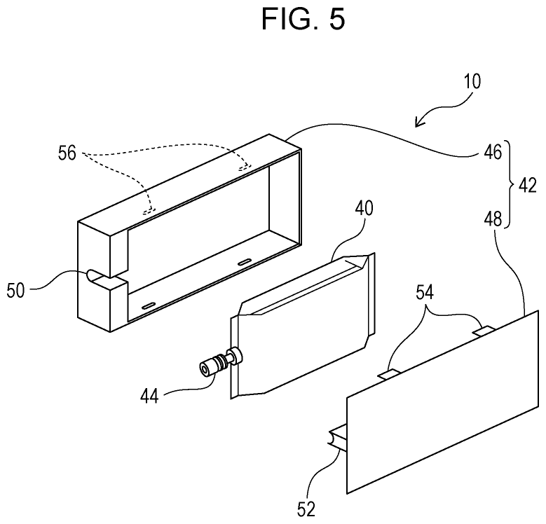

FIG. 5 shows an example of the ink pack as the container of the present embodiment. FIG. 5 is an exploded perspective view of the ink pack. An ink cartridge 10 includes an ink pack 40 which is filled with ink, and a cartridge case 42 which includes a main body case 46 and a lid 48 for accommodating and protecting the ink pack 40. The ink pack 40 includes an ink supply port 44. The main body case 46 includes a cutout portion 50 and a groove portion 56, and the lid 48 includes a pressing portion 52 and a hook portion 54. In the ink cartridge 10, the ink pack 40 is accommodated in the main body case 46 and the lid 48. At this time, the ink supply port 44 is fitted into the cutout portion 50, and is fixed by being interposed between the pressing portion 52 and the cutout portion 50. The main body case 46 and the lid 48 are sealed by fitting the hook portion 54 into the groove portion 56. A film-like member constituting the ink pack 40 and storing ink in the ink pack may be a member constituting the above-described ink pack.

### 2. 1. 2. Ink Bottle

The ink bottle is not particularly limited, and examples thereof include an ink bottle for replenishing ink to a printer having a continuous ink supply system (CISS). The ink bottle is not particularly limited, and may include, for example, an ink discharge port and a bottle main body that stores ink, for example.

The ink bottle is preferably a resin bottle. The present disclosure is particularly useful because of the excellence thereof in terms of lightness and costs, and because the dissolved nitrogen concentration tends to be high due to low airtightness of the lid and low gas barrier performance of the container itself.

The resin constituting the bottle main body is not particularly limited, and examples thereof include a polyester resin and a polyolefin resin. Such a member is excellent in impact resistance and is preferable, but on the other hand, the gas barrier performance is relatively low, and thus the ink storage body of the present embodiment is particularly useful.

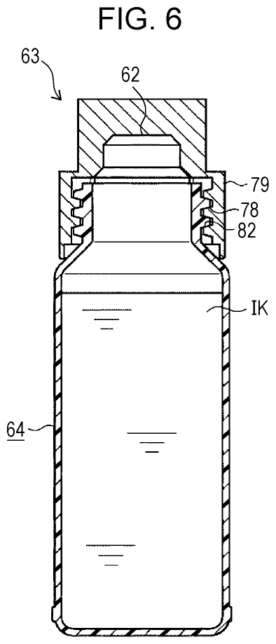

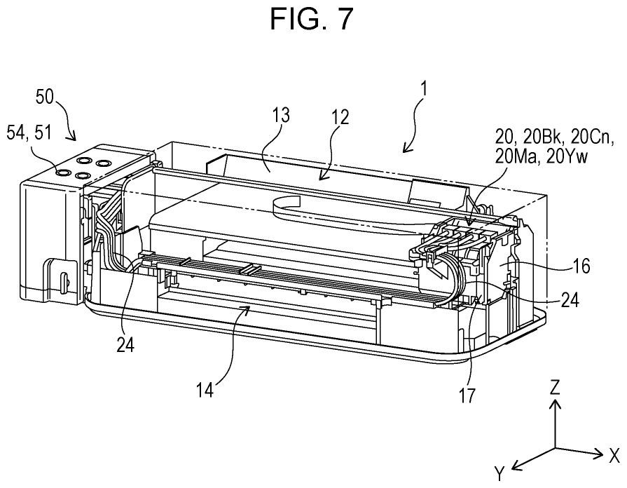

FIG. 6 shows an example of the ink bottle as the container of the present embodiment. FIG. 7 is a cross-sectional view of an example of the ink bottle. The ink composition IK described above is stored in an ink bottle 63. The ink bottle 63 has a cylindrical container main body portion 64 serving as a main body thereof. An ink outlet 62 allowing the ink to flow out of the container main body portion 64 is opened and formed at a distal end of the container main body portion 64. When the ink bottle 63 is stored, a part of the container main body portion 64 is covered by a bottomed cylindrical cap 79 so as to surround the ink outlet 62, and the ink outlet 62 is sealed from the outside. A helical thread 78 is formed in the inside of the cap 79, and the helical thread 78 is rotationally engaged and secured to a helical thread 82 formed on an outer surface of the container main body portion 64. When the ink is made to flow out, the cap 79 is removed.

The container main body portion 64 in the ink bottle 63 is a bottle-shaped member capable of storing the ink composition therein.

The bottle-shaped member described above is preferably made of, for example, a polyolefin resin such as polypropylene. Such a member is excellent in impact resistance and is preferable, but on the other hand, the gas barrier performance is relatively low, and thus the ink storage body of the present embodiment is particularly useful.

### 3. Ink Jet Recording Method

An ink jet recording method according to the present embodiment includes a step of ejecting the ink jet ink composition from an ink jet head to attach the ink jet ink composition to a recording medium. In addition, the ink jet recording method may further include a transporting step of transporting the recording medium, and the attaching step and the transporting step may be performed at the same time. Another step may be included as necessary.

### 4. Ink Jet Recording Apparatus

An ink jet recording apparatus of the present embodiment includes the ink composition described above, and an ink jet head having a nozzle that discharges the ink composition described above onto a recording medium, and preferably further includes: a supply flow path that causes the ink composition described above to flow and is connected to the ink jet head; and a filter unit that is provided in the supply flow path of the ink jet head. The ink jet recording apparatus further includes a mounting portion (not shown) on which the ink storage body is mounted, and the ink is supplied from the ink storage body to the ink jet head. As the ink storage body of this example, an ink pack is preferably used.

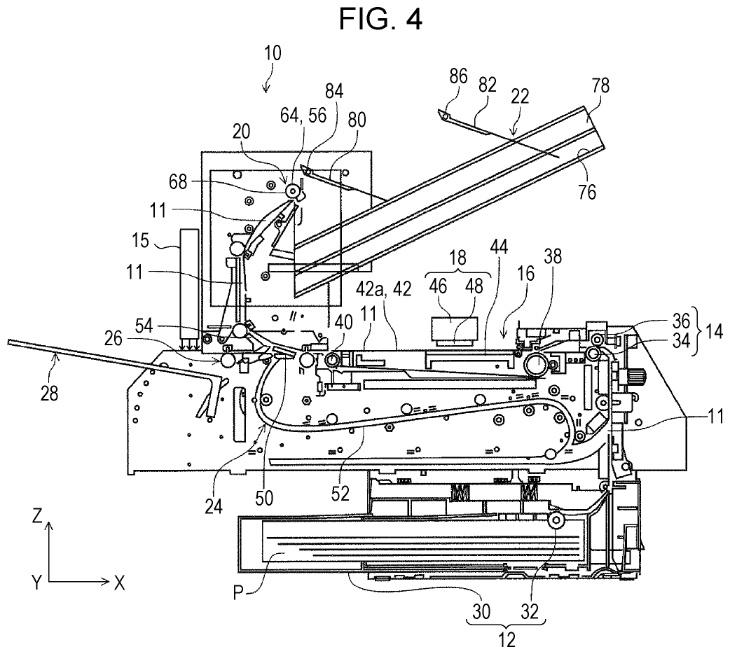

FIG. 4 shows an example of an ink jet recording apparatus that can be used in the present embodiment. The ink jet recording apparatus according to the present embodiment will be described in more detail with reference to the drawing. In an X-Y-Z coordinate system shown in the drawings, an X direction indicates a length direction of a recording medium, a Y direction indicates a width direction of the recording medium in a transportation path in the recording apparatus, and a Z direction indicates an apparatus height direction.

The recording apparatus 10 is, for example, a line type ink jet printer capable of performing high-speed and high-density printing. The recording apparatus 10 includes a feeding section 12 that stores a recording medium P such as paper, a transporting section 14, a belt transporting section 16, a recording section 8, a face-down (Fd) discharge section 20 as a “discharge unit,” a face-down (Fd) mounting section 22 as a “mounting section,” a reverse path section 24 as a “reverse transport mechanism,” a face-up (Fu) discharge section 26, and a face-up (Fu) mounting section 28.

The feeding section 12 is disposed in a lower portion of the recording apparatus 10. The feeding section 12 includes a feeding tray 30 that stores the recording medium P and a feeding roller 32 that feeds the recording medium P stored in the feeding tray 30 to a transporting path 11.

The recording medium P accommodated in the feeding tray 30 is fed to the transporting section 14 along the transporting path 11 by the feeding roller 32. The transporting section 14 includes a transport driving roller 34 and a transport driven roller 36. The transport driving roller 34 is rotationally driven by a driving source (not shown). In the transporting section 14, the recording medium P is nipped between the transport driving roller 34 and the transport driven roller 36 and transported to the belt transporting section 16 positioned on the downstream side in the transporting path 11.

The belt transporting section 16 includes, in the transporting path 11, a first roller 38 positioned on the upstream side, a second roller 40 positioned on the downstream side, an endless belt 42 rotatably attached to the first roller 38 and the second roller 40, and a support 44 that supports an upper section 42a of the endless belt 42 between the first roller 38 and the second roller 40.

The endless belt 42 is driven to move from the +X direction to the −X direction in the upper section 42a by the first roller 38 or the second roller 40 driven by a driving source (not shown). Therefore, in the belt transporting section 16, the recording medium P transported from the transporting section 14 is further transported to the downstream side in the transporting path 11.

The recording section 8 includes a line type ink jet head 48 and a head holder 46 that holds the ink jet head 48. The recording section 8 may be of a serial type in which an ink jet head is provided on a carriage that reciprocates in the Y-axis direction. The ink jet head 48 is arranged so as to face the upper section 42a of the endless belt 42 supported by the support 44. When the recording medium P is transported in the upper section 42a of the endless belt 42, the ink jet head 48 ejects ink onto the recording medium P to perform recording. The recording medium P is transported to the downstream side in the transporting path 11 by the belt transporting section 16 while recording is performed.

A first branch portion 50 is provided on the downstream side in the transporting path 11 of the belt transporting section 16. The first branch portion 50 is configured to be capable of switching between: the transporting path 11 for transporting the recording medium P to the Fd discharge section 20 or the Fu discharge section 26; and a reverse path 52 of the reverse path section 24 for reversing the recording surface of the recording medium P and transporting the recording medium P again to the recording section 8. The recording surface of the recording medium P, which is transported to the reverse path 52 switched by the first branch portion 50, is reversed in the transport process in the reverse path 52, and the recording medium P is transported again to the recording section 8 such that the surface opposite to the initial recording surface faces the ink jet head 48.

A second branch portion 54 is further provided on the downstream side of the first branch portion 50 along the transporting path 11. The second branch portion 54 is configured to be capable of switching the transporting direction of the recording medium P so as to transport the recording medium P toward the Fd discharge section 20 or transport the recording medium P toward the Fu discharge section 26.

The recording medium P transported toward the Fd discharge section 20 in the second branch portion 54 is discharged from the Fd discharge section 20 and mounted on the Fd mounting section 22. At this time, the recording medium P is mounted such that the recording surface thereof faces the Fd mounting section 22. Further, the recording medium P transported toward the Fu discharge section 26 in the second branch portion 54 is discharged from the Fu discharge section 26 and mounted on the Fu mounting section 28. At this time, the recording medium P is mounted so that the recording surface thereof faces the side opposite to the Fu mounting section 28.

FIG. 7 is a perspective view of another example of a recording apparatus used in the recording method of the present embodiment. An ink jet recording apparatus 1 of the figure has an ink tank 50 and an ink supply tube 24 for supplying ink from the ink tank 50 to an ink jet head 17. In an ink supply path between the ink tank 50 and the ink jet head 17, there is a sub-tank 20 that relays ink. The sub-tank 20 for relaying ink may be provided if necessary.

The ink tank 50 has an ink pouring port 54 through which ink is poured from an ink storage body (not shown). In the present embodiment, the container of the ink storage body is an ink bottle, and the ink in the ink bottle is poured into the ink tank 50 through the ink pouring port 54.

The recording apparatus according to the present embodiment is a recording apparatus in which the ink tank 50 is a CISS tank (continuous ink supply system tank), and ink is poured into the ink tank 50 from an ink bottle on an as-needed basis, so that replacement of an ink cartridge is unnecessary, and recording can be continuously performed without interrupting recording.

The ink tank 50 includes, for example, four ink tanks so that four types of ink can be poured, and also has four ink pouring ports. Four ink supply tubes 24 to four ink jet heads 17 are also provided.

The ink jet head 17 records an image on a recording medium by ejecting liquid droplets of an ink composition. In addition, a carriage 16 on which the sub-tank 20 and the ink jet head 17 are mounted and which is capable of reciprocating in the X-axis direction, a paper feed port 12 that feeds the recording medium, a paper discharge port 14 that discharges the recording medium, and a support section 13 that supports the recording medium to be fed to the paper feed port 12 are provided. The ink jet head 17 has a nozzle surface provided at a position facing the recording surface of the recording medium, and ejects ink in the form of liquid droplets from a plurality of nozzles provided on the nozzle surface to attach the ink to the recording surface of the recording medium.

The ink jet recording method of this example may be performed using a recording apparatus having: an ink tank in which the container is an ink bottle and which has an ink pouring port through which the ink jet ink composition is poured from the ink bottle; and an ink jet head to which the above-described ink jet ink composition is supplied from the ink tank, which is preferable. Also in this case, as a result, the ink is supplied from the ink bottle to the ink jet head.

### 5. Recording Medium

The recording medium used in the present embodiment is not particularly limited, and examples thereof include an absorptive recording medium, a low-absorptive recording medium, and a non-absorptive recording medium, and the absorptive recording medium is preferable.

Examples of the absorptive recording medium include plain paper such as electrophotographic paper having high ink permeability and ink jet paper (ink jet dedicated paper including an ink absorbing layer formed from silica particles or alumina particles or an ink absorbing layer formed from a hydrophilic polymer such as polyvinyl alcohol (PVA) or polyvinylpyrrolidone (PVP)).

Examples of the low-absorptive recording medium include art paper, coated paper, and cast paper, which have relatively low ink permeability and are used for general offset printing.

Examples of low-absorptive recording medium include films and plates of plastic such as polyvinyl chloride, polyethylene, polypropylene, polyethylene terephthalate (PET), polycarbonate, polystyrene, and polyurethane; plates of metal such as iron, silver, copper, and aluminum; and metal plates and plastic films produced by vapor deposition of these metals, and plates made of alloy such as stainless steel and brass; and a recording medium in which a film of plastic such as polyvinyl chloride, polyethylene, polypropylene, polyethylene terephthalate (PET), polycarbonate, polystyrene, or polyurethane is adhered to (coats) a paper substrate.

### 6. Recorded Material

A recorded material of the present embodiment is obtained by attaching the above-described ink composition to the recording medium. The recorded material of the present embodiment using the above-described ink composition is excellent in recording quality while reducing emission of carbon dioxide, and thus is excellent in terms of sustainable environmentally friendly measures.

### EXAMPLES

The present disclosure will be described in more detail with reference to Examples and Comparative Examples. The present disclosure is not limited by the following Examples.

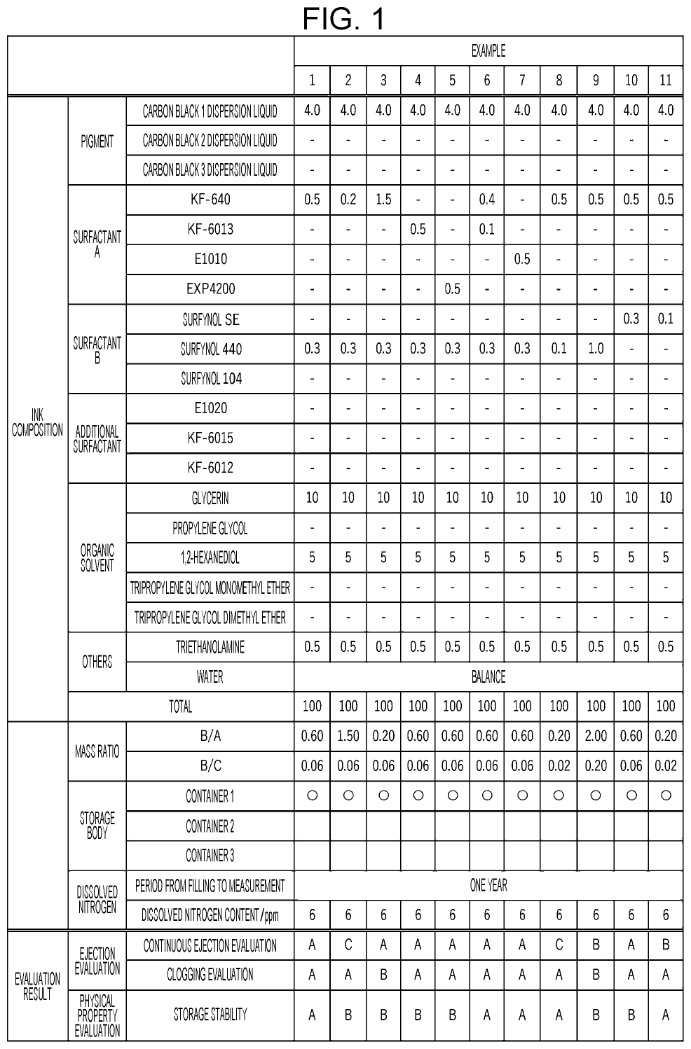

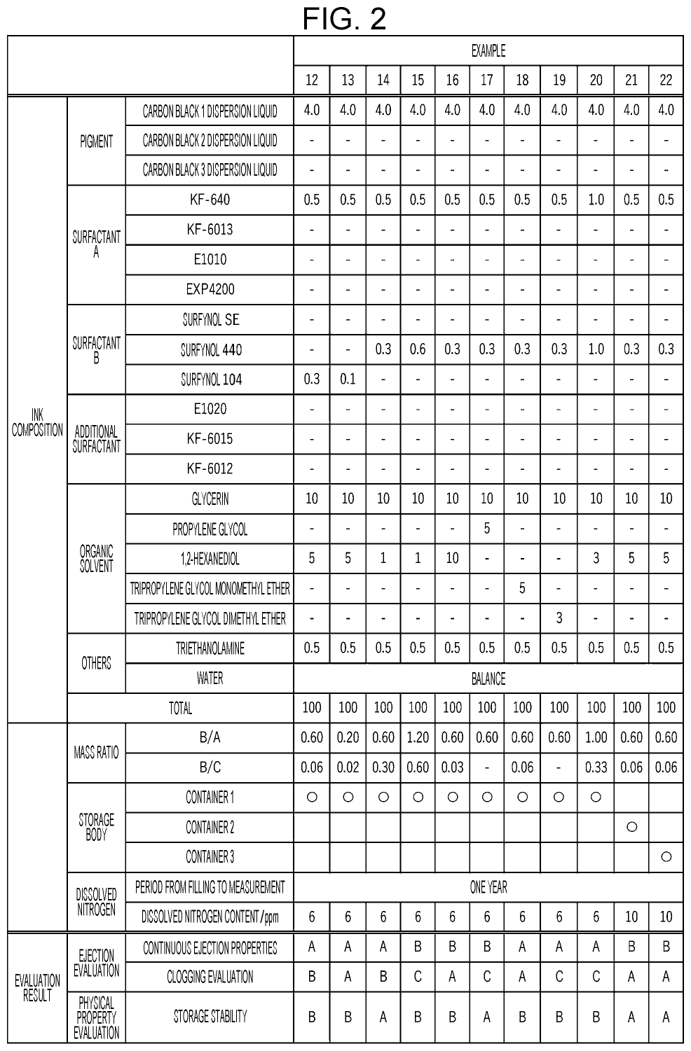

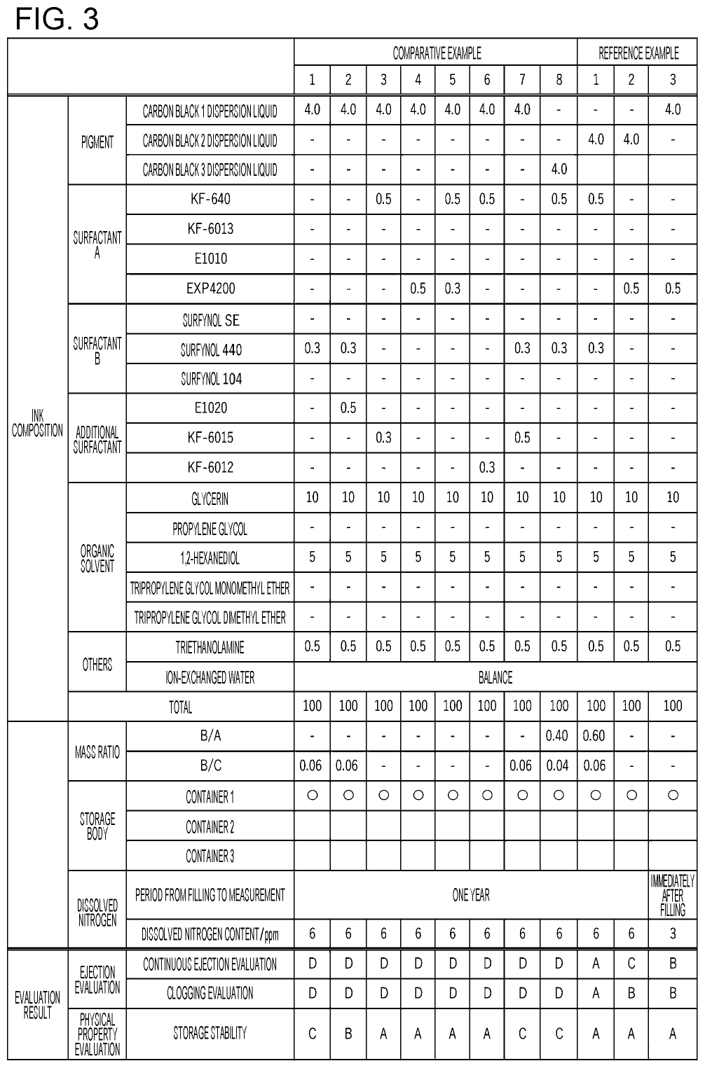

FIGS. 1, 2, and 3 show Tables 1, 2, and 3 showing compositions of respective ink compositions of Examples, Comparative Examples, and Reference Examples and evaluation results thereof. The numerical values of respective components of the ink compositions of the respective examples shown in the tables represent mass % unless otherwise specified. In addition, in the tables, the numerical values of the carbon black dispersion liquids represent mass % of the solid content of the component.

### 1. Preparation of Ink Composition

The ink jet ink composition of each example was obtained by putting each component in a tank for a mixture so as to achieve the composition described in Table 1, 2, or 3, mixing and stirring the components, and further filtering the mixture with a membrane filter. The numerical values of the individual components of each example shown in the tables represent mass % unless otherwise specified. In addition, in the tables, the numerical values represent mass % of the solid contents of the components. The pigments are the solid contents of the pigments.

The abbreviations used in Tables 1, 2, and 3 and the details of the product components are as follows. Non-biomass means that the material is not derived from a plant, but from petroleum.

### Carbon Black

Carbon Black 1: vegetable oil carbon black (PRINTEX Nature, manufactured by Orion Engineered Carbons S.A.)
Carbon black 2: non-biomass carbon black (MA100, manufactured by Mitsubishi Chemical Corporation)
Carbon black 3: Binchotan carbon black (Kishu Binchotan charcoal powder, manufactured by Kiriya Chemical Co., Ltd.)

### Carbon Black 1 Dispersion Liquid

Carbon black 1 was subjected to pulverization processing and mixed with water. Thereafter, the liquid mixture was subjected to ozone treatment for 6 hours within an ozone concentration range of 5.5% to 6.0%. After the treatment, the carbon black was washed, potassium hydroxide was added thereto, and the mixture was dispersed in water. Consequently, a dispersion liquid of a self-dispersible carbon black pigment having potassium as a counter ion (hereinafter, referred to as the “carbon black 1 dispersion liquid”) was obtained. The volume-average particle diameter D50 of secondary particles of the carbon black pigment in the dispersion liquid measured by a dynamic light scattering method was 110 nm.

The carbon black was a self-dispersible pigment in which a carboxy group was introduced onto the surface of the carbon black by the above-described treatment.

### Carbon Black 2 Dispersion Liquid

A carbon black dispersion liquid 2 was obtained in the same manner except that the carbon black 2 was used. The volume average particle diameter D50 of secondary particles of the carbon black pigment in the dispersion liquid measured by a dynamic light scattering method was 90 nm.

### Carbon Black 3 Dispersion Liquid

A carbon black dispersion liquid 3 was obtained in the same manner except that the carbon black 3 was used. The volume average particle diameter D50 of secondary particles of the carbon black pigment in the dispersion liquid measured by a dynamic light scattering method was 180 nm.

### Surfactant

### Surfactant A

KF-640 (silicone-based surfactant, HLB value: 14, manufactured by Shin-Etsu Chemical Co., Ltd.) KF-6013 (silicone-based surfactant, HLB value: 10, manufactured by Shin-Etsu Chemical Co., Ltd.)

E1010 (acetylene glycol-based surfactant, HLB value: 13 to 14, manufactured by Nissin Chemical Industry, Co., Ltd.)

EXP4200 (acetylene glycol-based surfactant, HLB value: 10 to 13, manufactured by Nissin Chemical Industry, Co., Ltd.)

### Surfactant B

SURFYNOL SE (acetylene glycol-based surfactant, HLB value: 6, manufactured by Nissin Chemical Industry, Co., Ltd.)

SURFYNOL 440 (acetylene glycol-based surfactant, HLB value: 8, manufactured by Nissin Chemical Industry, Co., Ltd.)

SURFYNOL 104 (acetylene glycol-based surfactant, HLB value: 4, manufactured by Nissin Chemical Industry, Co., Ltd.)

### Additional Surfactant

E1020 (acetylene glycol-based surfactant, HLB value: 15 to 16, manufactured by Nissin Chemical Industry, Co., Ltd.)
KF-6015 (silicone-based surfactant, HLB value: 5, manufactured by Shin-Etsu Chemical Co., Ltd.)
KF-6012 (silicone-based surfactant, HLB value: 7, manufactured by Shin-Etsu Chemical Co., Ltd.)

### Organic Solvent

Glycerin (SP value: 16.7)
Propylene glycol (SP value: 14.2)
1,2-Hexanediol (SP value: 12.2)
Tripropylene glycol monomethyl ether (SP value: 9.1)
Tripropylene glycol dimethyl ether (SP value: 7.4) Alkali

### Triethanolamine

Water

### Ion-Exchanged Water

### 2. Ink Storage Body

### Container 1

A film having a multilayer structure in which aluminum having a thickness of 30 nm was vapor-deposited on one surface of a low-density polyethylene (PE) film having a thickness of 80 μm was prepared. Thereafter, an ink pack (hereinafter, referred to as the “container 1”) for storing an ink composition was prepared using the obtained film.

### Container 2

A film having a multilayer structure in which a nylon film having a thickness of 30 μm was stacked on one surface of a low-density polyethylene (PE) film having a thickness of 80 μm was prepared. Thereafter, an ink pack (hereinafter, referred to as the “container 2”) for storing an ink composition was prepared using the obtained film.

### Container 3

An ink bottle (hereinafter, referred to as the “container 3”) was manufactured using polyethylene by stretch blow molding.

Each container had a volume of 200 ml.

### 2. 1. Dissolved Nitrogen Content

The ink jet ink composition prepared as described above was poured into each of the containers to produce a storage body. After a period from filling for each example in the table, the dissolved nitrogen content of the ink in the storage body was measured in terms of mass using a gas chromatograph 6890N (product name, manufactured by Agilent Technologies).

### 3. Evaluation Methods

### 3. 1. Continuous Ejection Properties

In a modified ink jet printer PX-H6000 (manufactured by Seiko Epson Corporation), the storage body used in the above-described dissolved nitrogen content measurement was set after the period from filling in the container for each example in the table, and the printer was filled with the ink jet ink composition stored in the storage body. Printer paper “p” (A4 size) manufactured by Fuji Xerox was set, and continuous printing was performed at a resolution of 720 dpi×1440 dpi. The nozzles were checked every five sheets, and it was confirmed whether printing was normally performed without missing dots, misalignment, or the like. Evaluation was made according to the following criteria, and results are shown in tables. The evaluation criteria are as follows. In an example in which the ink container was the container 3, a CISS tank was attached to the ink jet printer, and the CISS tank was filled with the ink from the container.

### Evaluation Criteria

A: normal printing is possible for 100 or more sheets
B: normal printing is possible in range of 50 or more and less than 100 sheets
C: normal printing is possible in range of 5 or more and less than 50 sheets
D: missing dots or flight misalignment occurs in less than 5 sheets

### 3. 2. Clogging Evaluation

In the same manner as for the continuous ejection properties, all rows of nozzles of a print head of a modified ink jet printer PX-H6000 (manufactured by Seiko Epson Corporation) were filled with the ink jet ink composition, and it was confirmed that the ink was normally ejected from all rows. Thereafter, the print head was shifted from the standby position and stopped in the printing area, and was left in that state in an environment of 40° C. and a relative humidity of 20% for three days. Thereafter, the print head was returned to the standby position, and the nozzle surface was wiped using a rubber wiper. Then, the cleaning process was executed, and the number of cleaning cycles required until the ejection from all the nozzles was recovered was counted.

### Evaluation Criteria

A: all nozzles are recovered by cleaning once or less
B: all nozzles are recovered by cleaning twice or more and five times or less
C: all nozzles are recovered by cleaning 6 times or more and 10 times or less
D: not all nozzles are recovered even after 11 times or more of cleaning

### 3. 3. Storage Stability

Each ink composition after the period from filling in the container for each example in the table was put in a 50 cc glass sample bottle, and the sample bottle was sealed and put in a thermostatic bath at 50° C. and left for 3 days in an environment of 50° C. Then, after returning to room temperature, the viscosity was measured. The viscosity was obtained by adjusting the temperature of the ink composition to 25° C. and reading the viscosity at a shear rate of 200/sec using a viscoelasticity tester MCR-300 (product name) manufactured by Physica Corporation. Then, the viscosity change rate after 14 days from the storage in the sample bottle with respect to the initial viscosity of the ink composition before the sample bottle was sealed was calculated. The evaluation criteria are as follows.

### Evaluation Criteria

A: viscosity change rate is less than ±5%
B: viscosity change rate is ±5% or more and less than ±10%
C: viscosity change rate is ±10% or more

### 4. Evaluation Results

Table 1 shows the composition of the ink used in each example and the evaluation results. It can be seen from Table 1 that the ink jet ink compositions containing a vegetable oil CB, a surfactant A having an HLB value of 10 or more and less than 15, and a surfactant B which was an acetylene glycol-based surfactant having an HLB value of 3 or more and less than 10 were excellent in ejection stability and storage stability.

Although not shown in the tables, a film was produced by attaching an aluminum foil layer with a thickness of 10 μm to one side of a low-density polyethylene (PE) film with a thickness of 80 μm, and an ink pack was produced as the container 4 in the same manner as described above using the obtained film, and when evaluation was conducted in the same manner as in Comparative Example 4 using the ink pack, the dissolved nitrogen content was 3 ppm even after a period of one year, and the continuous ejection evaluation and the clogging evaluation were rated as B.

What is claimed is:

1. An ink jet ink composition comprising:
a pigment; and
a surfactant, wherein
the pigment includes carbon black derived from a vegetable oil or carbon black derived from a recycled raw material,
the surfactant includes:
a surfactant A having an HLB value of 10 or more and less than 15; and
a surfactant B which is an acetylene glycol-based surfactant having an HLB value of 3 or more and less than 10, and
the ink jet ink composition is an aqueous ink.

2. The ink jet ink composition according to claim 1, further comprising:
an organic solvent C having an SP value of 8 (cal/cm³)^{1/2} or more and 14 (cal/cm³)^{1/2} or less.

3. The ink jet ink composition according to claim 2, wherein
a mass ratio (B/C) of a content of the surfactant B to a content of the organic solvent C is 0.3 or less.

4. The ink jet ink composition according to claim 1, wherein
a mass ratio (B/A) of a content of the surfactant B to a content of the surfactant A is 0.1 or more and 1.0 or less.

5. The ink jet ink composition according to claim 1, wherein
the carbon black is a self-dispersible pigment.

6. The ink jet ink composition according to claim 1, wherein
the surfactant A includes one or more selected from the group consisting of silicone-based surfactants and acetylene glycol-based surfactants.

7. The ink jet ink composition according to claim 2, wherein
the organic solvent C includes one or more selected from the group consisting of polyols and glycol ethers.

8. The ink jet ink composition according to claim 1, wherein
a content of the surfactant A is 0.1 mass % or more and 1.5 mass % or less with respect to a total amount of the ink jet ink composition, and
a content of the surfactant B is 0.1 mass % or more and 1.0 mass % or less with respect to the total amount of the ink jet ink composition.

9. The ink jet ink composition according to claim 2, wherein
a content of the organic solvent C is 1.0 mass % or more and 15 mass % or less with respect to a total amount of the ink jet ink composition.

10. An ink storage body comprising:
the ink jet ink composition according to claim 1; and
a container storing the ink jet ink composition.

11. The ink storage body according to claim 10, wherein
the ink jet ink composition has a dissolved nitrogen concentration of 2 ppm or more.

12. The ink storage body according to claim 10, wherein
the container is an ink pack including a member having a multilayer structure, or is an ink bottle including a resin.

13. A recording method comprising:
ejecting the ink jet ink composition according to claim 1 from an ink jet head to attach the ink jet ink composition to a recording medium.
